(19) United States
(12) Patent Application Publication
(10) Pub. No.: US 2018/0227721 A1
(43) Pub. Date: Aug. 9, 2018

(54) MULTICHANNEL RECIEVER WITH ADAPTIVE ANTENNA FOR IMPROVING ADVERTISING PACKETS

(71) Applicant: WiSilica Inc., Laguna Hills, CA (US)

(72) Inventors: Dennis Ching Chung Kwan, San Diego, CA (US); Suresh Kumar Singamsetty, Aliso Viejo, CA (US)

(21) Appl. No.: 15/813,134

(22) Filed: Nov. 14, 2017

Related U.S. Application Data
(60) Provisional application No. 62/421,634, filed on Nov. 14, 2016.

(51) Int. Cl. H04W 4/23; H04W 4/80; H04W 72/00

(52) U.S. Cl. CPC H04W 4/23; H04W 84/18; H04W 72/005; H04W 4/80

(57) ABSTRACT

A system and apparatus improves the communication of advertising packets in a mesh network by utilizing multiple channel receivers and adaptive antennas. In one embodiment, a receiver may simultaneously receive wireless signals from more than one channel. In another embodiment, the receivers may utilize adaptive antennas when switching between receiving channels.

### CROSS-REFERENCE TO RELATED APPLICATIONS

This present disclosure claims the benefit of U.S. Provisional Application Ser. No. 62/421,634, filed on Nov. 14, 2016.

### BACKGROUND

A mesh network is a type of machine communication system in which each client node (sender and receiver of data messages) of the network also relays data for the network. All client nodes cooperate in the distribution of data in the network. Mesh networks may in some cases also include designated router and gateway nodes (e.g., nodes that connect to an external network such as the Internet) that are or are not also client nodes. The nodes are often laptops, cell phones, or other wireless devices. The coverage area of the nodes working together as a mesh network is sometimes called a mesh cloud.

Mesh networks can relay messages using either a flooding technique or a routing technique. Flooding is a routing algorithm in which every incoming packet, unless addressed to the receiving node itself, is forwarded through every outgoing link of the receiving node, except the one it arrived on. With routing, the message is propagated through the network by hopping from node to node until it reaches its destination. To ensure that all its paths remain available, a mesh network may allow for continuous connections and may reconfigure itself around broken paths. In mesh networks there is often more than one path between a source and a destination node in the network. A mobile ad hoc network (MANET) is usually a type of mesh network. MANETs also allow the client nodes to be mobile.

A wireless mesh network (WMN) is a mesh network of radio nodes. Wireless mesh networks can self-form and self-heal and can be implemented with various wireless technologies and need not be restricted to any one technology or protocol. Each device in a mobile wireless mesh network is free to move, and will therefore change its routing links among the mesh nodes accordingly.

Mesh networks may be decentralized (with no central server) or centrally managed (with a central server). Both types may be reliable and resilient, as each node needs only transmit as far as the next node. Nodes act as routers to transmit data from nearby nodes to peers that are too far away to reach in a single hop, resulting in a network that can span larger distances. The topology of a mesh network is also reliable, as each node is connected to several other nodes. If one node drops out of the network, due to hardware failure or moving out of wireless range, its neighbors can quickly identify alternate routes using a routing protocol.

Referring to FIG. 1, an embodiment of a wireless mobile mesh network 100 includes a server node 102, a router node 110, a router node 112, a router node 106, a router node 104, a gateway node 114, and a gateway node 108. The server node 102, the gateway node 114, and the gateway node 108 also operate as router nodes. Every node in the network participates in the routing of communications in the wireless mobile mesh network 100. The gateway node 114 and gateway node 108 provide an interface between the wireless mobile mesh network 100 and an external network, such as the Internet or a local area network. The server node 102 provides some level of centralized management for the wireless mobile mesh network 100, and may be optional if each node acts autonomously to self-manage. One or more of the nodes may be fixed in location, some of the nodes may be mobile, or all of the nodes may be mobile.

Conventional Bluetooth Low Energy (BLE) receivers in mesh networks may receive three advertising broadcast frequencies (2402 MHz, 2426 MHz, and 2480 MHz); however, these receivers may receive only one frequency at a time. To compensate, the receiver may be dynamically altered to receive broadcasts from the three frequencies over a period of time (i.e., frequency hopping). However, this may result in lost data as a transmit device may be broadcasting with one specific frequency, but the receiver may be receiving at a different frequency; or additional resources (e.g., battery power) may need to be utilized for the device to broadcast on the three frequencies. Transmit devices have conventionally transmitted the same data three times on the three different frequencies. As the conventional receiver may wait until the three channels are received to further transmit the data, each receiver may be limited as to the number of devices (or nodes) that it may re-transmit (e.g., ˜25 nodes per receiver). Also, as future BLE devices may utilize more than three channels (e.g., 40 channels in BLE 5.0), backwards compatible receivers may be utilized with no change to the physical layer.

Referring to FIG. 2, a conventional receiver system 200 comprises a filter 202, a multiplier 204, a channel selector 206, and an A/D converter 208.

The filter 202 may receive a transmitted signal from a device. The filter 202 may allow transmitted signals of a specific type (e.g., BLE) or from specific sources (e.g., devices with a specific identifier) to be further transmitted to the multiplier 204. The multiplier 204 then selects for specific data based on input from the channel selector 206. The channel selector 206 may be set to a specific channel or may dynamically select a channel and send a signal to the multiplier 204 to perform the selection of the channel(s). The multiplier 204 sends the selected data to the A/D converter 208, which produces a converted signal.

Referring to FIG. 3, a conventional listener node-to-listener node data transmission 300 comprises a transmit period 302 and a re-transmit period 304. During the transmit period 302, data signals for each channel are sent by a first listener node to a second listener node. The conventional listener node-to-listener node data transmission 300 may be transmitting data signals received from transmit devices, such as a tags, or other listener nodes. Conventionally, the transmit devices transmit the multiple channels (here, channels 37, 38, and 39) serially and the first listener node is receiving one channel at a time. As data loss or errors may occur utilizing this method, a re-transmit period 304 may be utilized to help ensure the data signal is received by the second listener. During the transmit period 302 and the re-transmit period 304, new signals may not be received by the listener node that is transmitting or re-transmitting, which may result in data signals from transmit devices or other listener nodes not being received.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a wireless mobile mesh network 100 in accordance with one embodiment.

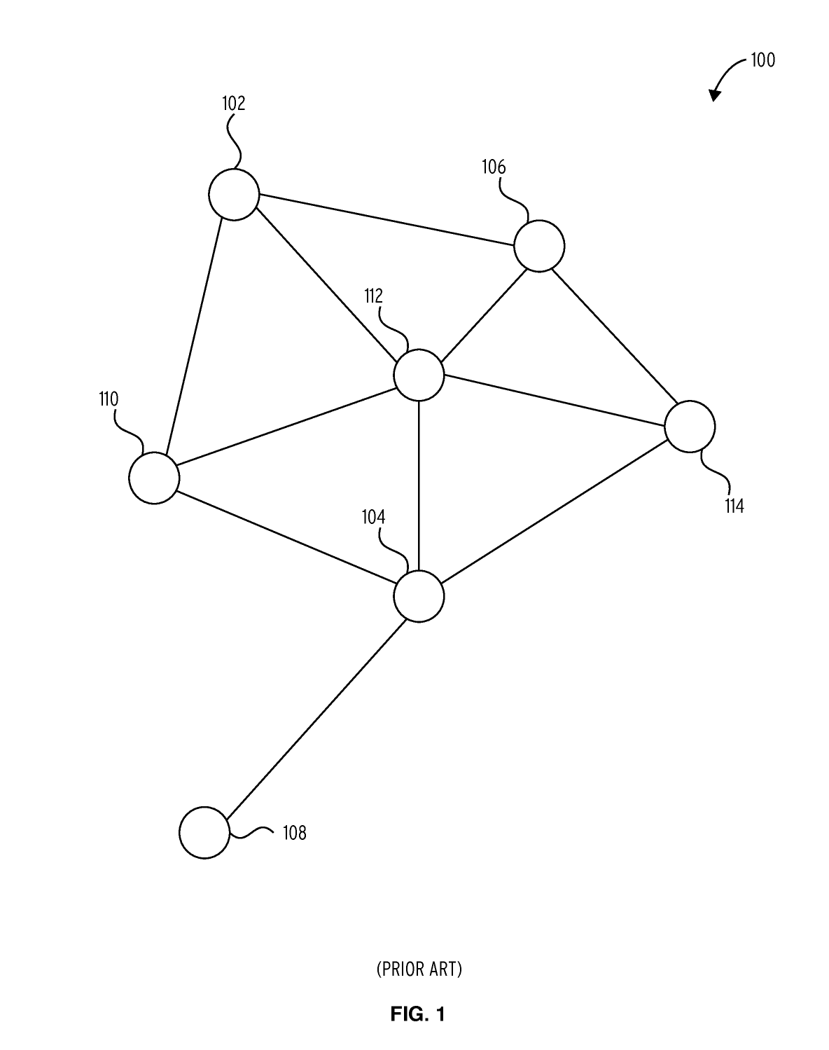

FIG. 2 illustrates an embodiment of a conventional receiver system 200.

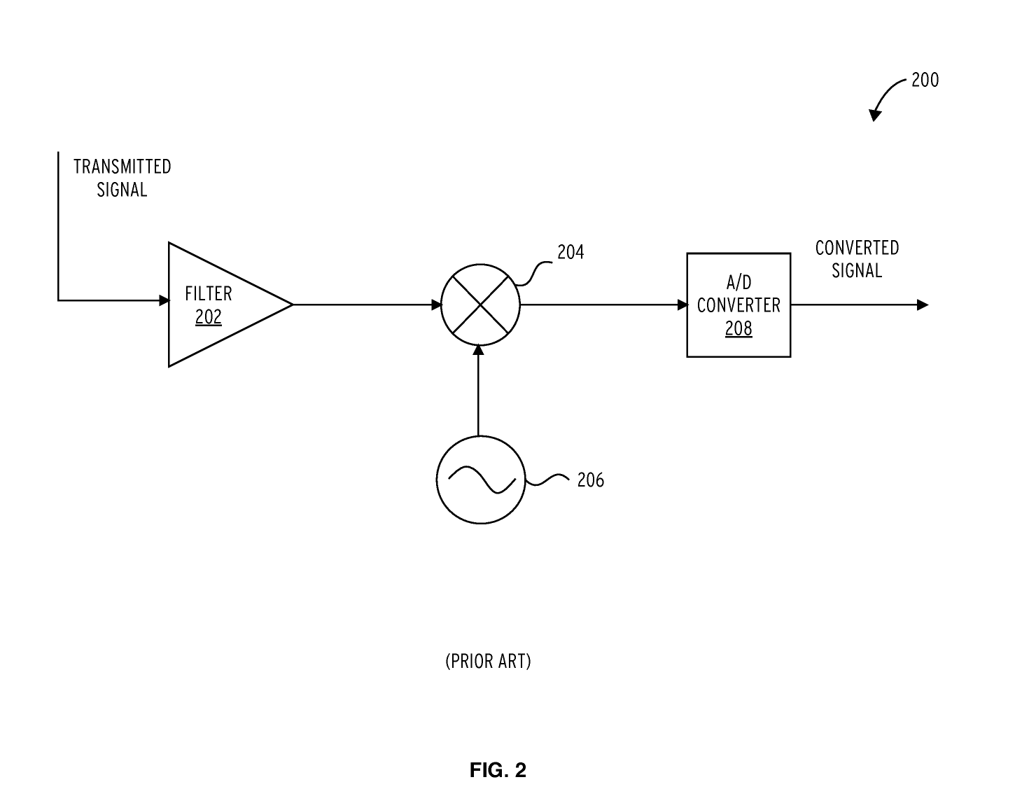

FIG. 3 illustrates an embodiment of conventional listener node-to-listener node data transmission 300.

FIG. 4 illustrates an embodiment of a receiver system 400.

FIG. 5 illustrates an embodiment of a transmit-receive system 500.

FIG. 6 illustrates an embodiment of a tag-listener node system 600.

FIG. 7 illustrates an embodiment of a system for integrating building automation with location awareness utilizing wireless mesh technology 700.

FIG. 8 illustrates an embodiment of system for integrating building automation with location awareness utilizing wireless mesh technology 800.

FIG. 9 illustrates an aspect of a system for integrating building automation with location awareness utilizing wireless mesh technology 900.

FIG. 10 illustrates an embodiment of a system for integrating building automation with location awareness utilizing wireless mesh technology 1000.

FIG. 11 illustrates an embodiment of a listener node-to-listener node data transmission 1100.

FIG. 12 illustrates an embodiment of a data signal receipt process 1200.

FIG. 13 illustrates an embodiment of a listener node receive and transmit process 1300.

FIG. 14 illustrates a system 1400 in accordance with one embodiment.

FIG. 15 illustrates an embodiment of a mobile wireless node 1502.

### DETAILED DESCRIPTION

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” in this context refers to logic implemented as processor-executable instructions in a machine memory (e.g. read/write volatile or nonvolatile memory or media).

“Combiner” (and “combine”) in this context refers to a logic element that combines two or more inputs into fewer (often a single) output. Example hardware combiners are adders, multipliers, arithmetic logic, time-division multiplexers and analog or digital modulators (these may also be implemented is software or firmware). Another type of combiner builds an association table or structure (e.g., a data structure instance having members set to the input values) in memory for its inputs. For example: val1, val2, val3->combiner logic->{val1, val2, val3} set.val1=val1; set.val2=val2; set.val3=val3; Other examples of combiners will be evident to those of skill in the art without undo experimentation.

“Selector” and “select” in this context refers to a logic element that selects one of two or more inputs to its output as determined by one or more selection controls. Examples of hardware selectors are multiplexers and demultiplexers. An example software or firmware selector is: if (selection_control==true) output=input1; else output=input2; Many other examples of selectors will be evident to those of skill in the art, without undo experimentation.

Wireless mesh nodes that may utilize the disclosed embodiments may implement various wireless protocols, including but not limited to:

“6LowPAN”: an acronym of IPv6 (Internet Protocol Version 6) over Low power Wireless Personal Area Networks. It is a wireless standard for low-power radio communication applications that need wireless internet connectivity at lower data rates for devices with limited form factor. 6LoWPAN utilizes the RFC6282 standard for header compression and fragmentation. This protocol is used over a variety of networking media including Bluetooth Smart (2.4 GHz) or ZigBee or low-power RF (sub-1 GHz) and as such, the data rates and range may differ based on what networking media is used.

“Bluetooth Low-Energy (BLE)—or Bluetooth Smart”: a wireless personal area network technology aimed at reduced power consumption and cost while maintaining a similar communication range as traditional Bluetooth. Like traditional Bluetooth, the frequency utilized is 2.4 GHz (ISM-Industrial, Scientific and Medical), the maximum range is generally 50-150 m with data rates up to 1 Mbps.

“Cellular”: a communication network where the last link is wireless. The network is distributed over land areas called cells and utilizes one of the following standards GSM/GPRS/EDGE (2G), UMTS/HSPA (3G), LTE (4G). Frequencies are generally one of 900/1800/1900/2100 MHz. Ranges are 35 km max for GSM; 200 km max for HSPA and typical data download rates are: 35-170 kps (GPRS), 120-384 kbps (EDGE), 384 Kbps-2 Mbps (UMTS), 600 kbps-10 Mbps (HSPA), 3-10 Mbps (LTE).

“LoRaWAN”: Low Power Wide Area Network, a media access control (MAC) protocol for wide area networks for low-cost, low-power, mobile, and secure bi-directional communication for large networks of up to millions of devices. LoRaWAN is employed on various frequencies, with a range of approximately 2-5 km (urban environment) to 15 km (suburban environment) and data rates of 0.3-50 kbps.

“NFC”: “Near Field Communication” and is a subset of RFID (Radio Frequency Identifier) technology. NFC is standardized in ECMA-340 and ISO/IEC 18092. It employs electromagnetic induction between two loop antennae when NFC devices are within range (10 cm). NFC utilizes the frequency of 13.56 MHz (ISM). Data rates range from 106 to 424 kbit/s.

“SigFox”: a cellular-style system that enables remote devices to connect using ultra-narrow band (UNB) technology and binary phase-shift keying (BPSK) to encode data. Utilizes the 900 MHz frequency and has a range of 30-50 km in rural environments and 3-10 km in urban environments with data rates from 10-1000 bps.

“Thread”: a wireless mesh network standard that utilizes IEEE802.15.4 for the MAC (Media Access Control) and Physical layers, IETF IPv6 and 6LoWPAN (IVP6). Thread operates at 250 kbps in the 2.4 GHz band. The IEEE 802.15.4-2006 version of the specification is used for the Thread stack.

“Weightless”: an open machine to machine protocol which spans the physical and mac layers. Operating frequency: 200 MHz to 1 GHz (900 MHz (ISM) 470-790 MHz (White Space)) Fractional bandwidth of spectrum band: <8% (for continuous tuning). Range up to 10 km and data Rates which range from a few bps up to 100 kbps

“WiFi”: a wireless network standard based on 802.11 family which consists of a series of half-duplex over-the-air modulation techniques that use the same basic protocol. Frequencies utilized include 2.4 GHz and 5 GHz bands with a range of approximately 50 m. Data rate of 600 Mbps maximum, but 150-200 Mbps is more typical, depending on channel frequency used and number of antennas (latest 802.11-ac standard should offer 500 Mbps to 1 Gbps).

“Z-Wave”: a wireless standard for reliable, low-latency transmission of small data packets. The Z-Wave utilizes the Z-Wave Alliance ZAD12837/ITU-T G.9959 standards and operated over the 900 MHz frequency in the US (Part 15 unlicensed ISM) and is modulated by Manchester channel encoding. Z-Wave has a range of 30 m and data rates up to 100 kbit/s.

“ZigBee”: a wireless networking standard for low power, low data rate, and lost cost applications. The Zigbee protocol builds upon the Institute of Electrical and Electronics Engineers (IEEE) 802.15.4 standard which defines a short range, low power, low data rate wireless interface for small devices that have constrained power, CPU, and memory resources. Zigbee operates over the 2.4 GHz frequency, with a range of 10-100 m and data rates of 250 kbps.

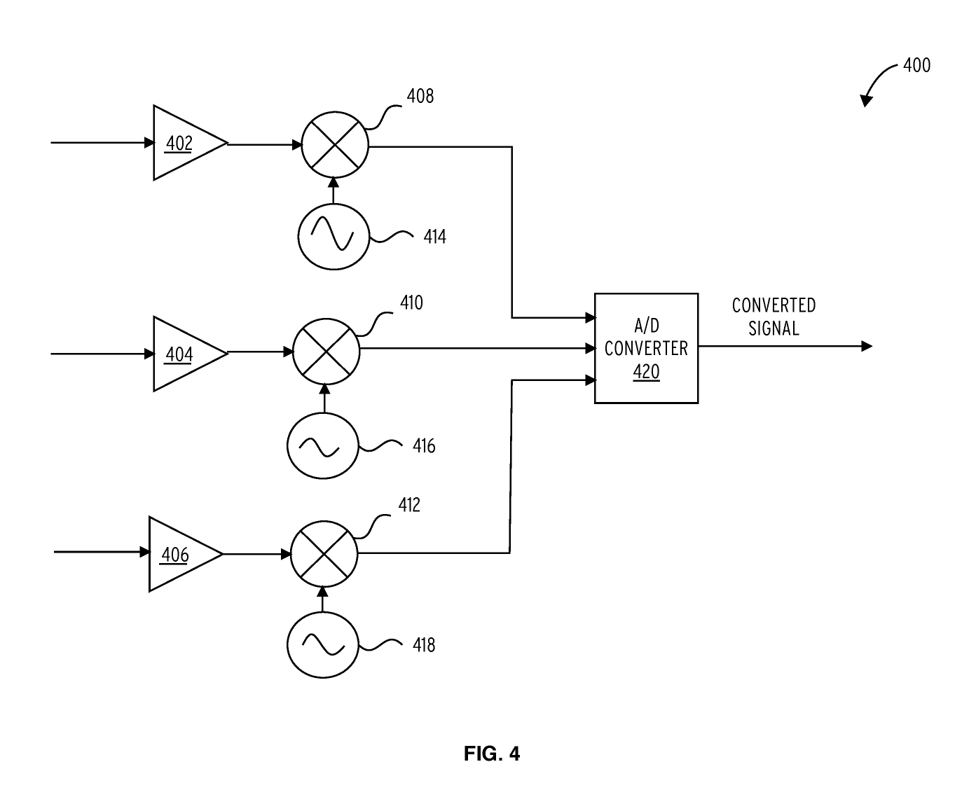

Referring to FIG. 4, a receiver system 400 comprises a first filter 402, a second filter 404, a third filter 406, a first multiplier 408, a second multiplier 410, a third multiplier 412, a first channel selector 414, a second channel selector 416, a third channel selector 418, and an A/D converter 420.

The first filter 402, second filter 404, and the third filter 406 may receive a transmitted signal from a device. The first filter 402, second filter 404, and the third filter 406 may allow transmitted signals of a specific type (e.g., BLE) or from specific sources (e.g., devices with a specific identifier) to be further transmitted to the first multiplier 408, the second multiplier 410, and the third multiplier 412, respectively. The first multiplier 408, the second multiplier 410, and the third multiplier 412 then selects for specific data based on input from the first channel selector 414, the second channel selector 416, and the third channel selector 418. Each of the first channel selector 414, the second channel selector 416, and the third channel selector 418 may be set to a specific channel or may dynamically select a channel and send a signal to the first multiplier 408, the second multiplier 410, and the third multiplier 412 to perform the selection of the channel(s). In some embodiments, each of the first channel selector 414, the second channel selector 416, and the third channel selector 418 are set to select a different channel. The first multiplier 408, the second multiplier 410, and the third multiplier 412 then send the selected data to the A/D converter 208, which may combine the data and produces a converted signal.

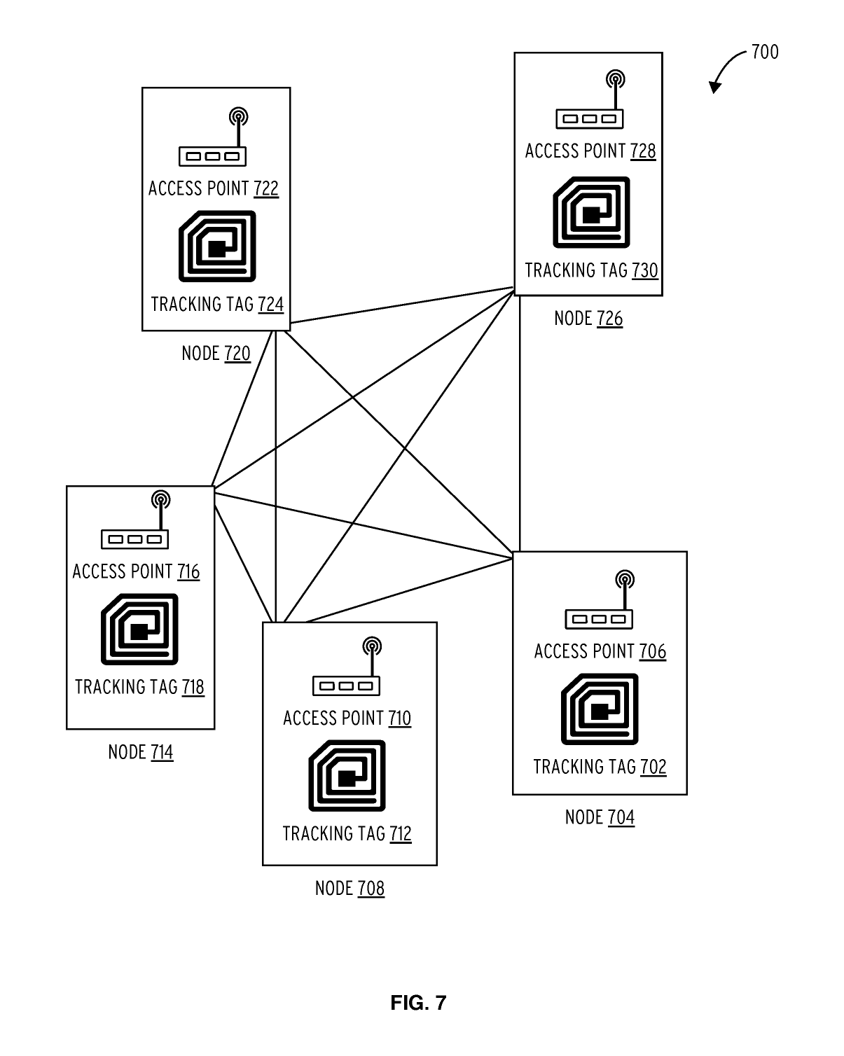

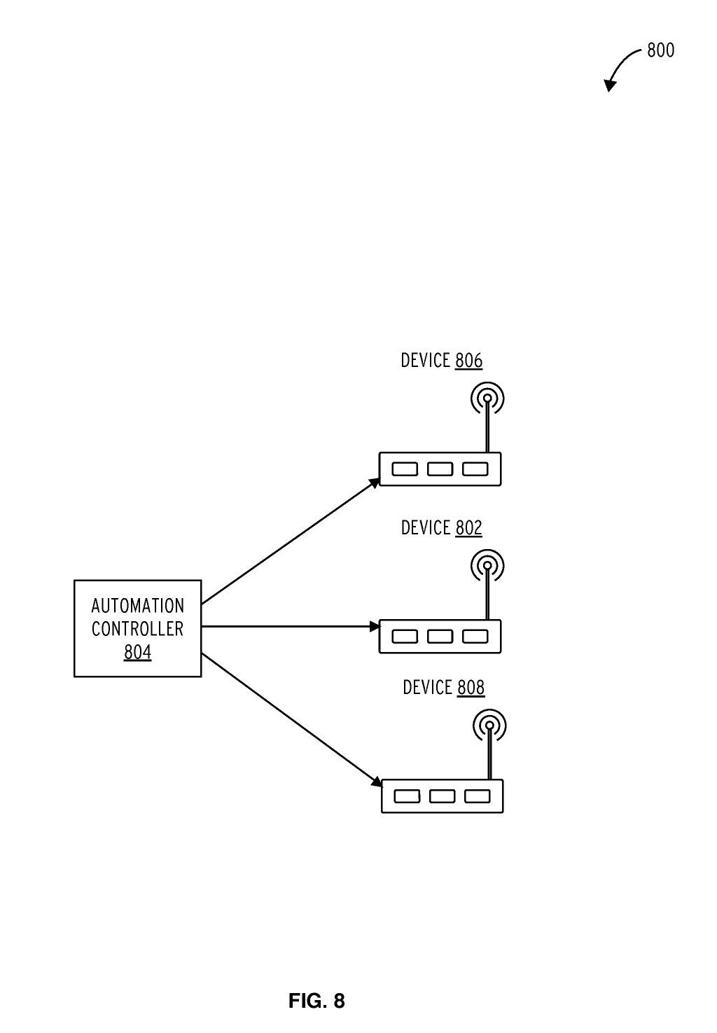

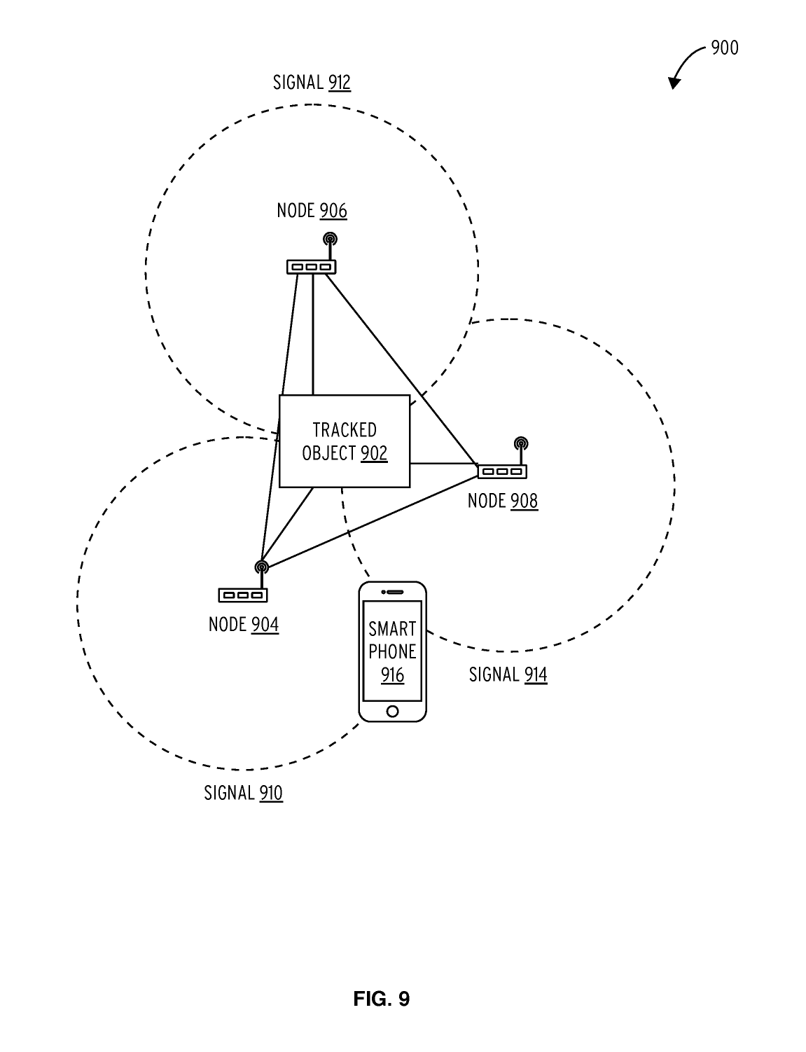

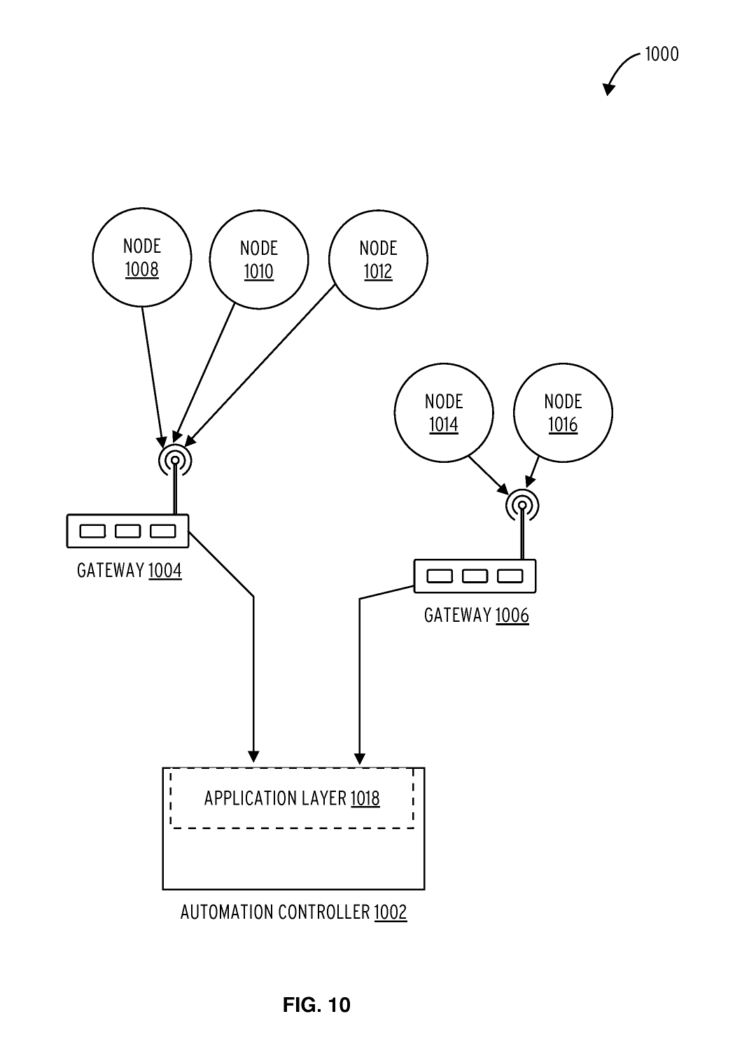

The receiver system 400 may be utilized as part of a mesh network or send the converted signal to, or through, the mesh network. The receiver system 400 may also be utilized to determine locations in a real time location system. The mesh network and real time location system are depicted in FIG. 7, FIG. 8, FIG. 9, and FIG. 10. In some embodiments, the receiver system 400 may be configured to receive wide end radio frequency signals, which may comprise multiple channels (e.g., 40 channels). These signals may be demodulated, and a converted signal may be generated that includes information corresponding to each channel received.

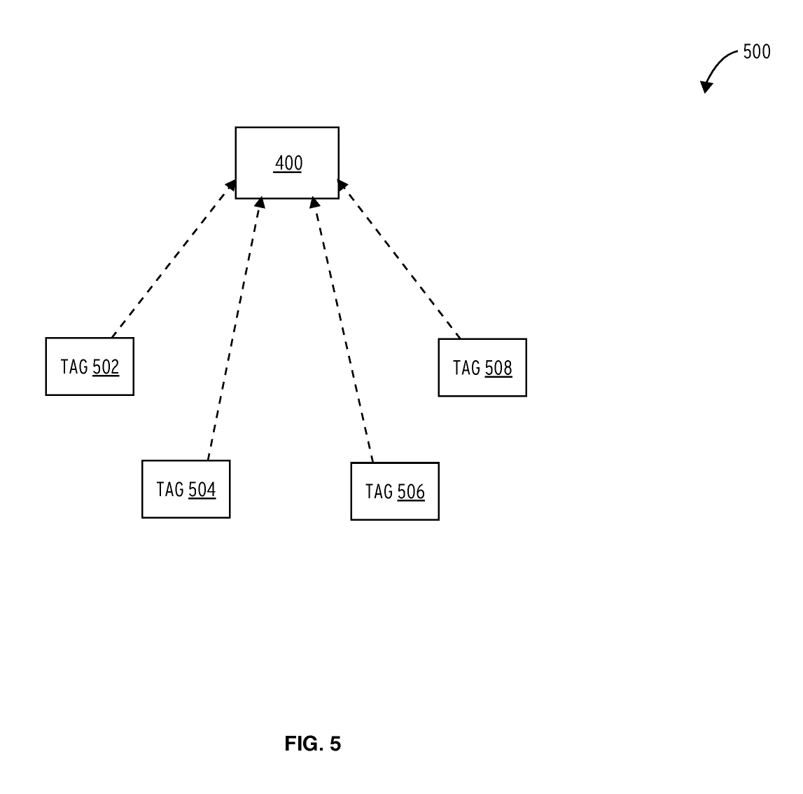

Referring to FIG. 5, a transmit-receive system 500 comprises a receiver system 400, a tag 502, a tag 504, a tag 506, and a tag 508.

Each of the tag 502, the tag 504, the tag 506, and the tag 508 transmits a signal that may be received by the receiver system 400. The signal may be broadcast on a specific frequency. Each of the tag 502, tag 504, the tag 506, and the tag 508 may broadcast the signal at multiple frequencies; however, as the receiver system 400 may receive multiple frequencies, the tag 502, the tag 504, the tag 506, and the tag 508 may emit the signal at one frequency, instead of at each of the multiple frequencies. The signal may comprise data associated with each tag, including an identifier. The receiver system 400 may determine a received signal strength indicator for each of the tag 502, the tag 504, the tag 506, and the tag 508. Each of the tag 502, the tag 504, the tag 506, and the tag 508 may have its location determined by a mesh network and a real time location system, which are depicted in FIG. 7, FIG. 8, FIG. 9, and FIG. 10.

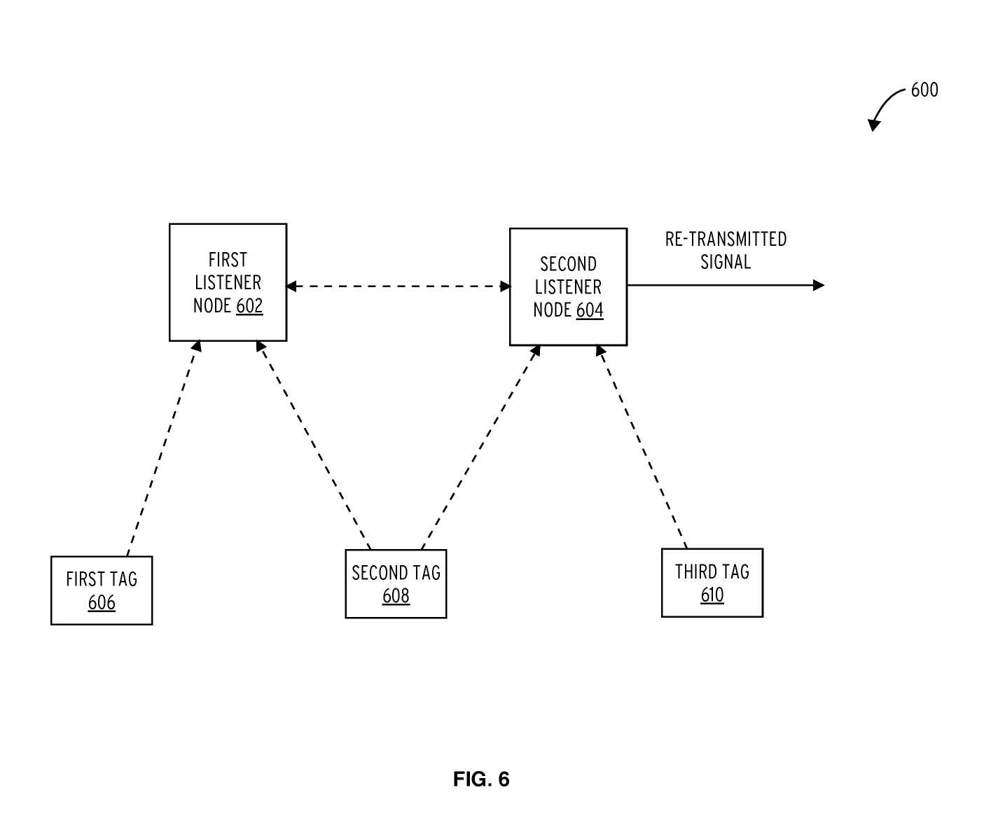

Referring to FIG. 6, the tag-listener node system 600 comprises a first listener node 602, a second listener node 604, a first tag 606, a second tag 608, and a third tag 610.

The first tag 606, the second tag 608, and the third tag 610 may transmit data signals at multiple frequencies. Each may also broadcast at a selected frequency of the multiple frequencies. The selected frequency may be dynamically altered during the operation of the tag.

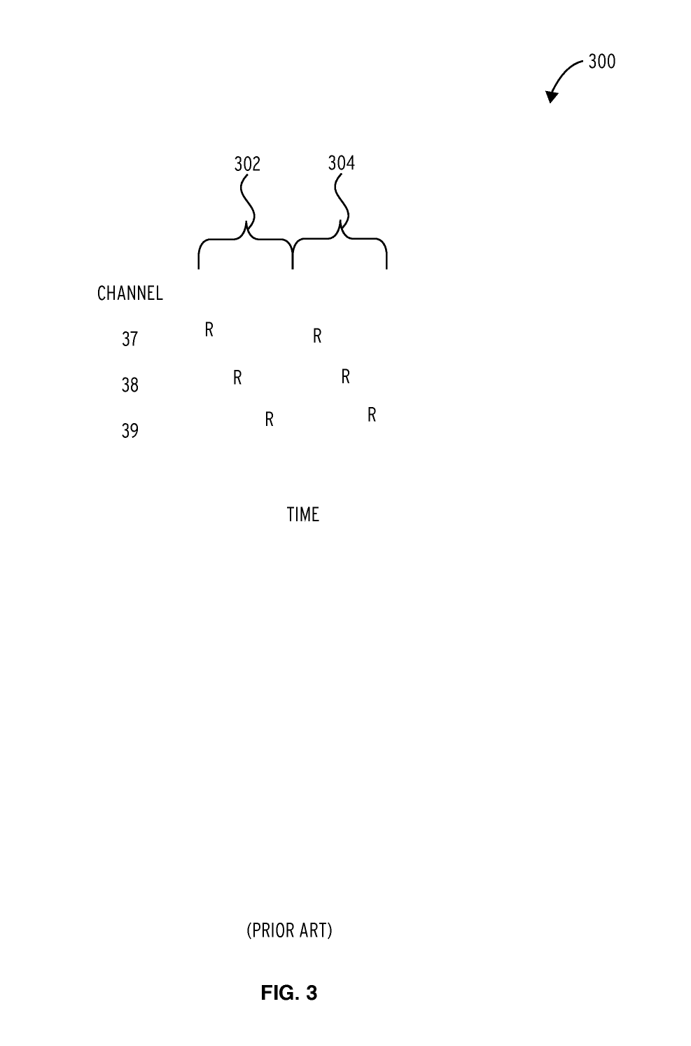

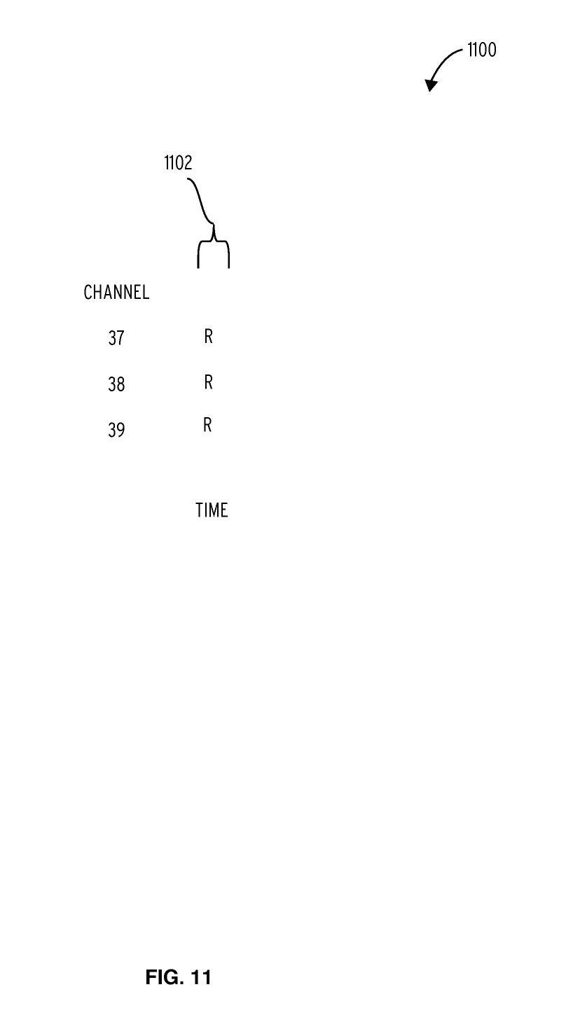

As depicted, the first listener node 602 receives signals from the first tag 606 and the second tag 608, and the second listener node 604 receives signals from the second tag 608 and the third tag 610. The signals may comprise identification information from the tag. The first listener node 602 and the second listener node 604 may determine a received signal strength indicator (RSSI) for each identification signal. Each listener node may also receive signals from devices other than tags, the signals comprising data such as identification, activation of the device, measurements performed by the device, etc. Each of the first listener node 602 and the second listener node 604 may comprise a receiver system 400. The first listener node 602 and the second listener node 604 may also transmit conventional listener node-to-listener node data transmission 300 or listener node-to-listener node data transmission 1100, which are depicted in FIG. 3 and FIG. 11, respectively.

The first listener node 602 and the second listener node 604 may re-transmit data to other listener nodes, such as to each other, or may re-transmit to other devices, including those devices included on a mesh network or a real time location system, which are depicted in FIG. 7, FIG. 8, FIG. 9, and FIG. 10. The first listener node 602 and the second listener node 604 may re-transmit on multiple frequencies, including those frequencies that each listener node is set to receive. For example, if a listener node may receive at three frequencies, 2402 MHz, 2426 MHz, and 2480 MHZ, the listener node may re-transmit at those same three frequencies.

An exemplary transmission/re-transmission sequence includes the first listener node 602 (L1) receiving identification data from the first tag 606 and the second tag 608 (i.e., T1, T2). The first listener node 602 determines the RSSI for each. The first listener node 602 then re-transmits the following to the second listener node 604, (T2, L1, RSSI; T1, L1, RSSI). The second listener node 604 receives identification data from the second tag 608 and the third tag 610 (i.e., T2, T3). The second listener node 604 may then re-transmit the data received from the first listener node 602, the second tag 608, and the third tag 610 as (Relay(T2, L1, RSSI); Relay(T1, L1, RSSI); T3, L2, RSSI; T2, L2, RSSI).

The first listener node 602 and the second listener node 604 may receive and transmit data in accordance with FIG. 10 and FIG. 11. The listener node-to-listener node data transmission 1100 may be implemented into a mesh network and/or real time location system, which are depicted which are depicted in FIG. 7, FIG. 8, FIG. 9, and FIG. 10.

FIG. 7 illustrates an embodiment of a system for integrating building automation with location awareness utilizing wireless mesh technology 700, including node 720, node 726, node 704, node 714, and node 708.

The node 720 comprises the tracking tag 724, and the access point 722. The node 726 comprises the access point 728 and the tracking tag 730. The node 704 comprises the tracking tag 702 and the access point 706. The node 708 comprises the access point 710 and the tracking tag 712. The node 714 comprises the access point 716 and the tracking tag 718.

The access point 706, the access point 710, the access point 716, the access point 722, and the access point 728 may comprise the receiver system 400 to receive data signals from the tracking tag 702, the tracking tag 712, the tracking tag 718, the tracking tag 724, and the tracking tag 730. The receiver system 400 may also be utilized to send data signals between the nodes.

The system for integrating building automation with location awareness utilizing wireless mesh technology 700 may utilize the transmit-receive system 500 and the tag-listener node system 600 to send and receive data signals from a tracking tag (or tag) to an access point.

The system for integrating building automation with location awareness utilizing wireless mesh technology 800 includes a device 802, an automation controller 804, a device 806, and a device 808.

The device 802, the automation controller 804, the device 806, and the device 808 may comprise the receiver system 400 to send and receive data signals.

The system for integrating building automation with location awareness utilizing wireless mesh technology 800 may utilize the tag-listener node system 600 to send and receive data signals from a tracking tag (or tag) to an access point. Here, the device 802, the device 806, and the device 808 may be a listener node as depicted in the tag-listener node system 600.

FIG. 9 illustrates an embodiment of a system for integrating building automation with location awareness utilizing wireless mesh technology 900, which includes node 906, tracked object 902, node 908, node 904, signal 912, signal 914, signal 910, and a smart phone 916.

The system for integrating building automation with location awareness utilizing wireless mesh technology 900 may comprise the receiver system 400 to receive the signal 910, the signal 912, the signal 914, and data signals from the tracked object 902, and to send and receive data signals between nodes. The transmit-receive system 500 may be utilized by the node 904, the node 906, the node 908 to receive the signal 910, the signal 912, the signal 914 from the tracked object 902. In this case, the tracked object 902 may be a tag. The tag-listener node system 600 may be utilized to receive signals from the tracked object 902 by the node 904, the node 906, and the node 908; to send signals between the nodes (wherein each node acts as a listener node); and to send signals to the smart phone 916.

FIG. 10 illustrates an embodiment of a system for integrating building automation with location awareness utilizing wireless mesh technology 1000, which includes a node 1008, a node 1010, a node 1012, a node 1014, a node 1016, a gateway 1004, a gateway 1006, an application layer 1018, and an automation controller 1002.

The system for integrating building automation with location awareness utilizing wireless mesh technology 1000 may utilize the receiver system 400, the transmit-receive system 500, and the tag-listener node system 600 to send and receive data signals. For example, the node 1008 may incorporate the receiver system 400 to receive signals from a tag and send the received data signal to the gateway 1004, which may utilize the receiver system 400 similarly.

Referring to FIG. 11, a listener node-to-listener node data transmission 1100 comprises a transmit period 1102.

During the transmit period 1102, a signals comprising information for each channel (here, channels 37, 38, and 39) are sent by a listener node to another node (e.g., another listener node, server, etc.). As each listener node is receiving at multiple channels (i.e., frequencies), a listener node transmitting to another listener node may send data signals at each frequency at the same time, instead of each channel in series. This reduces the time period in which the data signal is transmitted by the listener node. Additionally, a re-transmit period may not be utilized, as the likelihood of missing or incorrect data has be reduced. With the coordinated channel transmission and the non-utilization of a re-transmit period, the time that a listener node is transmitting, and not receiving, is reduced compared to the conventional listener node-to-listener node data transmission 300. Thus, a listener node may have an increased time to receive data signals from transmit devices (e.g., tags) and may receive data signals from a greater number of transmit devices. In some embodiments, the data is transmitted for each channel received.

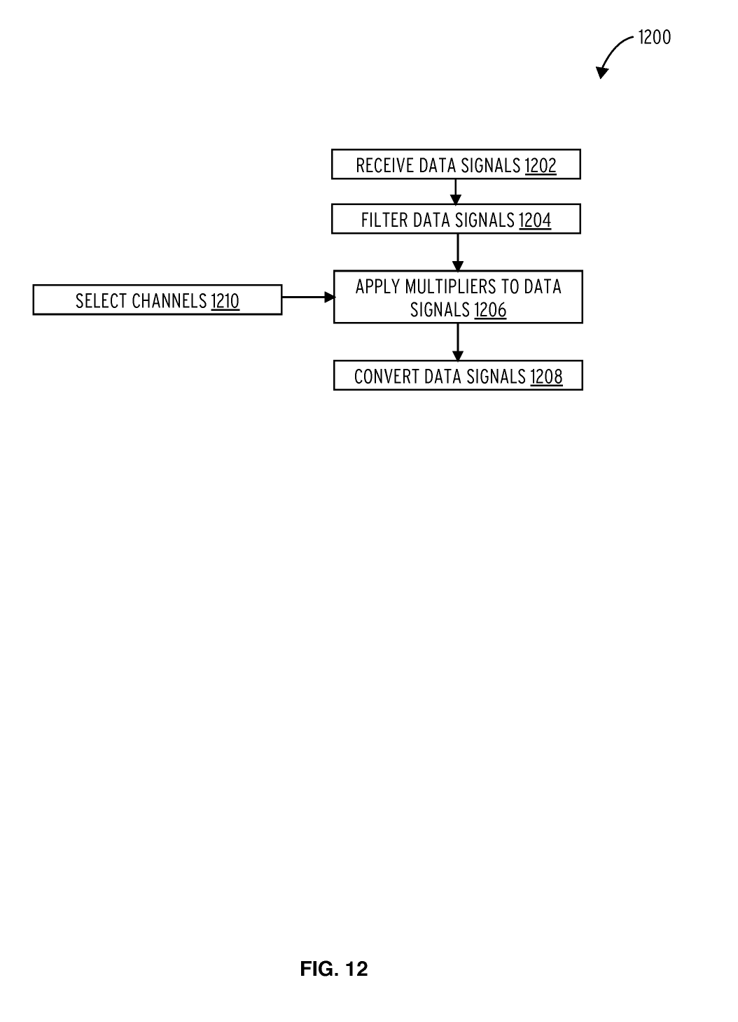

Referring to FIG. 12, the data signal receipt process 1200 receives data signals (block 1202). The data signals may be received on a single channel or multiple channels (e.g., the receiver system 400 may receive three channels). The data signals are filtered (block 1204). This may occur for each of the channels. The filtering process may exclude data signals from other channels that may cause interference, which may cause errors in interpreting the data signals. Multipliers are then applied to the data signals to select specific channels (block 1206 and block 1210). Multiple channels may be selected based on the receiver system (e.g., three channels may be selected in the receiver system 400). The data signals are then converted (block 1208). The data signal may be converted from an analog signal to a digital signal. The conversion process may also combine multiple signals into a single signal. For example, BLE channels 37, 38, and 39 may be combined as depicted in FIG. 11.

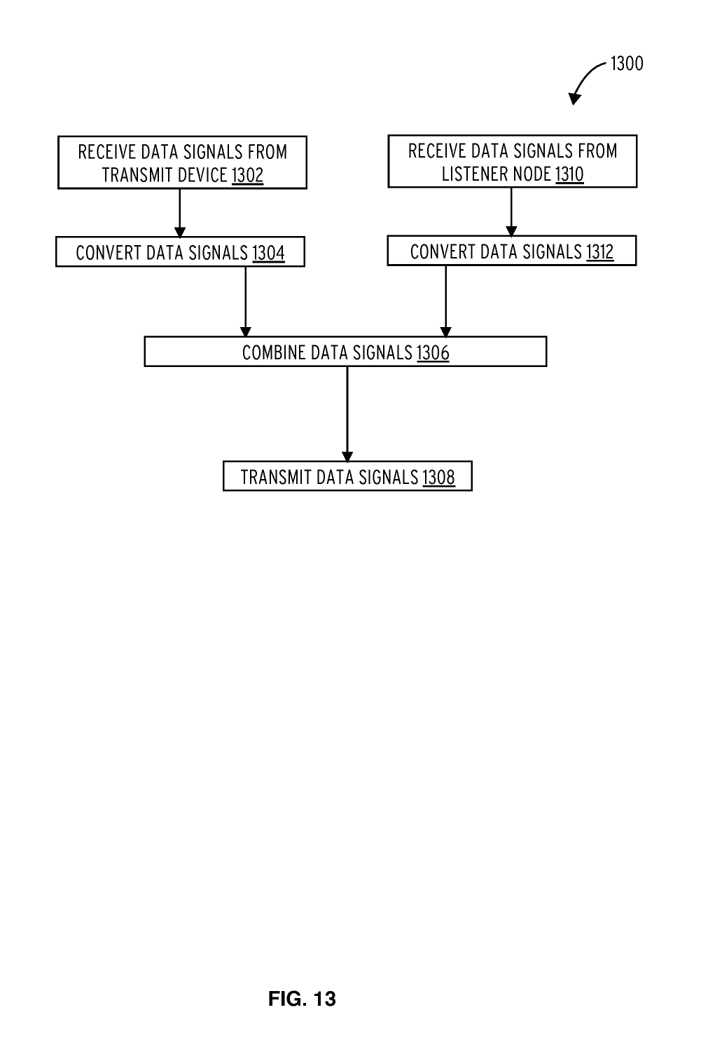

Referring to FIG. 13, the listener node receive and transmit process 1300 receives data signals from transmit devices (block 1302), such as tags, and listener nodes (block 1310). The data signals are converted (block 1304 and block 1312). The conversion process may utilize the data signal receipt process 1200 to filter and select for specific channels. The converted data signals are then combined (block 1306) and sent to another device (block 1308). The other device may include another listener node, a server, etc.

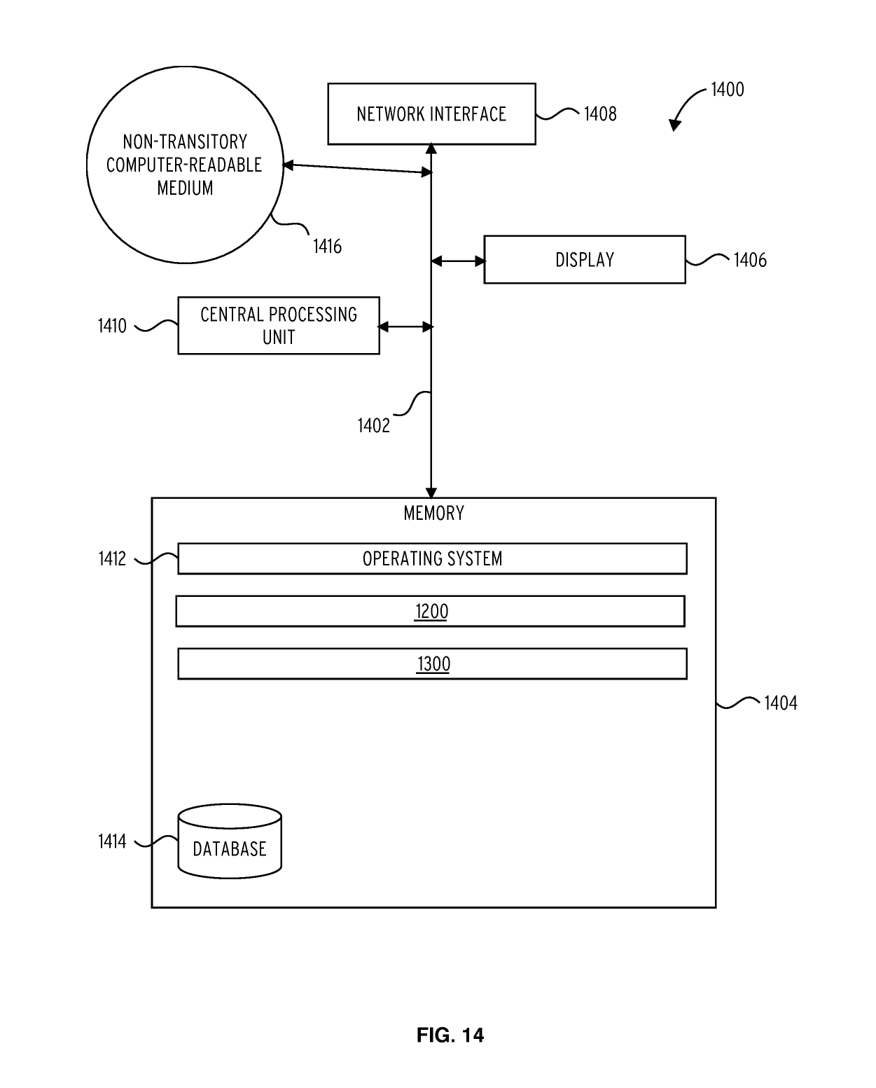

FIG. 14 illustrates several components of an exemplary system 1400 in accordance with one embodiment. In various embodiments, system 1400 may include a computing device that is capable of performing operations such as those described herein. In some embodiments, system 1400 may include many more components than those shown in FIG. 14. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 1400 may comprise one or more physical and/or logical devices that collectively provide the functionalities described herein. In some embodiments, system 1400 may comprise one or more replicated and/or distributed physical or logical devices.

In some embodiments, system 1400 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 1400 includes a bus 1402 interconnecting several components including a network interface 1408, a display 1406, a central processing unit 1410, and a memory 1404.

Memory 1404 generally comprises a random access memory (“RAM”) and permanent non-transitory mass storage device, such as a hard disk drive or solid-state drive. Memory 1404 stores an operating system 1412.

These and other software components may be loaded into memory 1404 of system 1400 using a drive mechanism (not shown) associated with a non-transitory computer-readable medium 1416, such as a floppy disc, tape, DVD/CD-ROM drive, memory card, or the like.

Memory 1404 also includes database 1414. In some embodiments, system 1400 may communicate with database 1414 via network interface 1408, a storage area network (“SAN”), a high-speed serial bus, and/or via the other suitable communication technology.

In some embodiments, database 1414 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

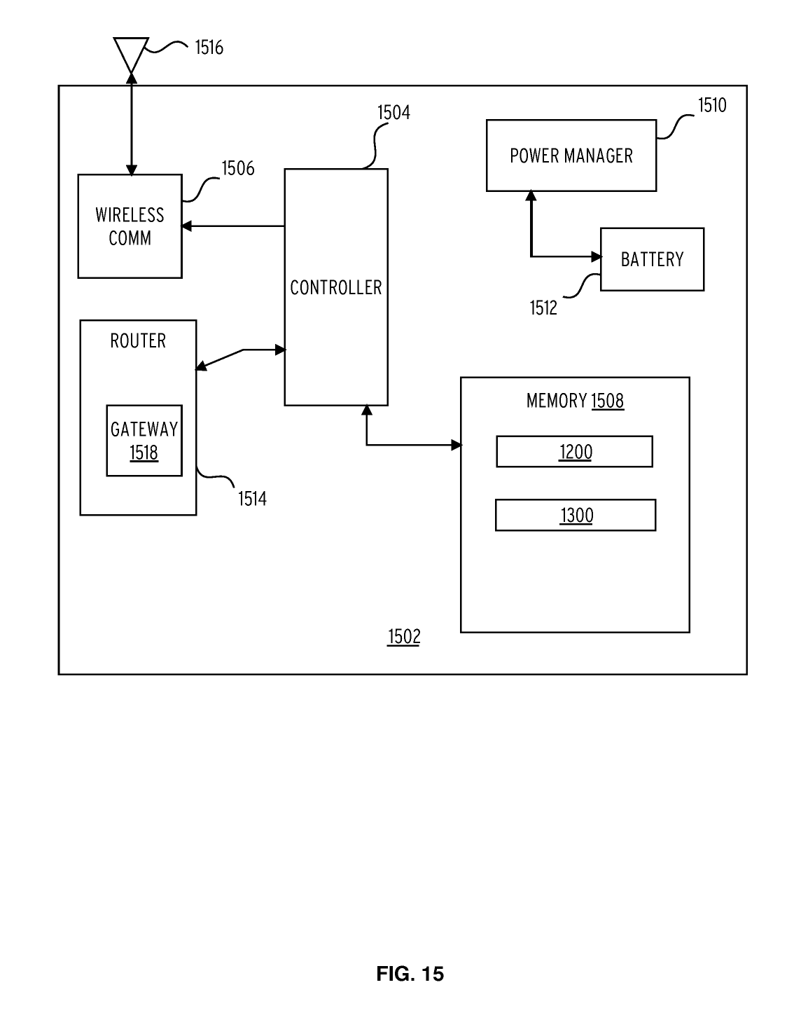

Referring to FIG. 15, a mobile wireless node 1502 includes an antenna 1516, a signal processing and system control 1504, a wireless communication 1506, a memory 1508, a power manager 1510, a battery 1512, a router 1514, and a gateway 1518.

The signal processing and system control 1504 controls and coordinates the operation of other components as well as providing signal processing for the mobile wireless node 1502. For example the signal processing and system control 1504 may extract baseband signals from radio frequency signals received from the wireless communication 1506 logic, and process baseband signals up to radio frequency signals for communications transmitted to the wireless communication 1506 logic. The signal processing and system control 1504 may comprise a central processing unit, digital signal processor, one or more controllers, or combinations of these components.

The wireless communication 1506 includes memory 1508 which may be utilized by the signal processing and system control 1504 to read and write instructions (commands) and data (operands for the instructions).

The router 1514 performs communication routing to and from other nodes of a mesh network (e.g., wireless mobile mesh network 100) in which the mobile wireless node 1502 is utilized. The router 1514 may optionally also implement a network gateway 1518.

The components of the mobile wireless node 1502 may operate on power received from a battery 1512. The battery 1512 capability and energy supply may be managed by a power manager 1510.

The mobile wireless node 1502 may transmit wireless signals of various types and range (e.g., cellular, WiFi, BlueTooth, and near field communication i.e. NFC). The mobile wireless node 1502 may also receive these types of wireless signals. Wireless signals are transmitted and received using wireless communication 1506 logic coupled to one or more antenna 1516. Other forms of electromagnetic radiation may be used to interact with proximate devices, such as infrared (not illustrated).

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually or collectively, by a wide range of hardware, software, firmware, or any combination thereof can be viewed as being composed of various types of circuitry.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

What is claimed:

1. A system for improving the communication of advertising packets in a mesh network by utilizing multiple channel receivers and adaptive antennas.
